(19) United States
(12) Patent Application Publication
(10) Pub. No.: US 2024/0308716 A1
(43) Pub. Date: Sep. 19, 2024

(54) APPARATUS FOR APPLYING A RESPECTIVE LABEL ON A CORRESPONDING CONTAINER

(71) Applicant: NEWTEC LABELLING S.R.L., Goito (MN) (IT)

(72) Inventor: Massimo PIPPA, Goito (MN) (IT)

(21) Appl. No.: 18/575,746

(22) PCT Filed: Jun. 23, 2022
(86) PCT No.: PCT/IB2022/055830

§ 371 Date: Dec. 29, 2023

(30) Foreign Application Priority Data
Jul. 2, 2021 (IT) 102021000017477

(51) Int. Cl. B65C 3/08; B65C 9/20; B65C 9/30

(52) U.S. Cl. CPC B65C 3/08; B65C 9/20; B65C 9/30

(57) ABSTRACT

An apparatus for applying a respective label, on a corresponding container, in particular in the form of a bottle, especially in the form of a container, or bottle, made of plastic material; in particular said label being adapted to circumferentially wrap the body of said container, or bottle, includes means for applying a corresponding adhesive or glue on one or more corresponding parts, in particular on the outermost parts, of the respective label; said means for applying a corresponding adhesive or glue being movable into a close position for engaging said one or more corresponding parts of said label and for applying thereon said adhesive or glue and a position disengaged from said label, and in particular which lets the label freely pass without said adhesive or glue being applied, which position disengaged from said label, and in particular which lets the label freely pass without said adhesive or glue being applied, is close to the label itself.

### FIELD OF APPLICATION OF THIS INVENTION

The present finding refers to an apparatus for applying a respective label to a corresponding container, in particular a container in the form of a corresponding bottle.

### STATE OF THE ART

Apparatuses are known for applying a respective label on a bottle made of plastic material, wherein said label is adapted to circumferentially wrap the body of the bottle, with corresponding overlap and mutual affixing, in particular by means of glue or adhesive, of the respective longitudinal or circumferential ends of the label itself, which apparatuses comprise means for applying a corresponding adhesive or glue on the respective label, and which application means are movable between a close position for engaging said one or more corresponding parts of said label and for applying thereon said adhesive or glue and a rest and moved away position, in the form of the impulse of a corresponding pneumatic cylinder. A problem felt in relation to this already known apparatuses, concerns the fact that, when glue is applied to a label that does not find a corresponding bottle or container to receive it, the label itself is lost and sticks anywhere on the machine with consequent inconveniences related to its removal, which is troublesome, generates losses of time for personnel and also possible machine downtimes, with corresponding loss of production. Furthermore, said pneumatic cylinder actuation, besides being to some extent relatively slow to be performed, is not particularly reliable with regard to the respective execution time. Therefore, according to another point of view, it would be desirable to achieve a faster and more reliable application of labels in the sector, in particular during the start-up step of the labelling operations.

### SUMMARY OF THE INVENTION

With the present invention it is therefore wished to propose a new solution and/or an alternative to the solutions known up to now and in particular it is proposed to overcome one or more of the drawbacks or problems referred to above, and/or to satisfy one or more requirements referred to above and/or in any case experienced in the art, and in particular which can be deduced from the above.

There is thus provided an apparatus for applying a respective label, on a corresponding container, in particular in the form of a bottle, especially in the form of a container or bottle made of plastic material; in particular said label being adapted to circumferentially wrap the body of said container, or bottle; the apparatus comprising means for applying a corresponding adhesive or glue on one or more corresponding parts, in particular on the outermost parts, of the respective label, said means for applying a corresponding adhesive or glue being movable into a close position for engaging said one or more corresponding parts of said label and for applying thereon said adhesive or glue; characterized in that said means for applying a corresponding adhesive or glue are movable into a position disengaged from said label, and in particular which lets the label freely pass without said adhesive or glue being applied, which position disengaged from said label, and in particular which lets the label freely pass without said adhesive or glue being applied, is close to the label itself.

In this way, it is possible, when there is no container, or bottle, in the position for receiving the respective label, to avoid applying glue on the corresponding label and thus prevent this label, by being lost, and wandering in the apparatus, from being able to get affixed in undesirable points thereof, forcing the need to carry out troublesome and time-consuming cleaning works, moreover with corresponding machine downtimes and related production losses.

### BRIEF DESCRIPTION OF THE DRAWINGS

This and other innovative aspects or respective advantageous embodiments, are however, set forth in the appended claims, the technical characteristics of which can be found, together with corresponding advantages achieved, in the following detailed description, illustrating a purely non-limiting example of the embodiment of the invention, which is made with reference to the appended drawings, in which:

FIG. 1 illustrates a schematic plan view from above of a preferred embodiment of apparatus according to the present invention;

FIG. 2A illustrates an enlarged schematic plan view from above of the preferred embodiment of apparatus according to the present invention, illustrating a position of said means for applying a corresponding adhesive or glue, on said label, which is resting and moved away from said label, or moved away from said means for transferring said label onto said container, or bottle;

FIG. 2B illustrates an enlarged schematic plan view from above of the preferred embodiment of apparatus according to the present invention, illustrating a position, on the part of said means for applying a corresponding adhesive or glue on said label which is for engaging said label and for applying thereon said adhesive or glue by said means;

FIG. 2C illustrates a schematic plan view from above of an enlarged detail of the preferred embodiment of apparatus according to the present invention, illustrating a position, on the part of said means for applying a corresponding adhesive or glue, on said label, which is disengaged from, and close to, said label and in particular which lets the label freely pass without said adhesive or glue being applied;

FIG. 3A illustrates a schematic plan view from above of the means that are adapted to move said applicator member, or roller, of the preferred embodiment of apparatus according to the present invention, illustrating the same means in the position in which said means for applying a corresponding adhesive or glue, on said label are in the rest position and moved away from said label, or moved away from said means for transferring said label onto said container, or bottle;

FIG. 3B illustrates a schematic plan view from above of the means that are adapted to move said applicator member, or roller, of the preferred embodiment of apparatus according to the present invention, illustrating the same means in the position in which said means for applying a corresponding adhesive or glue, on said label are in the position for engaging said label and for applying thereon said adhesive or glue;

FIG. 3C illustrates a schematic plan view from above of the means that are adapted to move said applicator member, or roller, of the preferred embodiment of apparatus according to the present invention, illustrating the same means in the position in which said means for applying a corresponding adhesive or glue, on said label are in the position disengaged from, and close to, said label and in particular which lets the label freely pass without said adhesive or glue being applied;

FIG. 4 illustrates a schematic side elevation view of the preferred embodiment of said means for applying a corresponding adhesive or glue, on said label according to the present invention;

FIG. 5 illustrates a longitudinal sectional schematic view of the preferred embodiment of eccentric according to the present invention.

### DETAILED DESCRIPTION OF PREFERRED EMBODIMENTS OF THE INVENTION

The attached figures illustrate a preferred embodiment of apparatus 10 for applying a respective label 11, on a corresponding container 13, in particular in the form of a bottle, and especially in the form of a container or bottle 13 made of plastic material.

As can be seen from the figures, in particular, said label 11 is adapted to circumferentially wrap the body of said container, or bottle, 13, with corresponding overlap and mutual affixing, in particular by means of glue or adhesive, of the respective longitudinal or circumferential ends of the label itself 11. In practice, a first end 111 of said label 11 is affixed to the outer surface of the body of said container, or bottle, 13, which is rotated with respect to its axis to drag said label 11 to wrap said container, or bottle, 13 and thus make the opposite end 112 of the label 11 adhere to the outer face of the label itself 11.

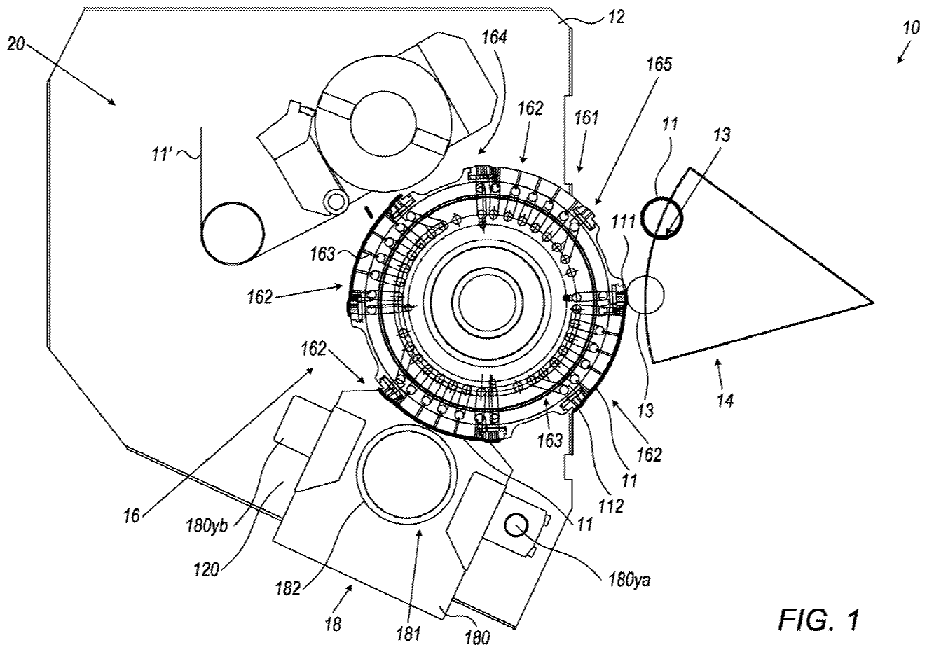

As can be seen from FIG. 1, the apparatus 10 comprises support means, or framing 12 for means 16 for transferring the respective label 11 onto the corresponding container, or bottle, 13, and means 18 for applying a corresponding adhesive or glue on one or more corresponding parts, in particular on the outermost parts 111, 112, of the respective label 11, in particular with said label 11 which is located on said means 16 for transferring said label 11 onto the corresponding container, or bottle, 13.

Furthermore, as illustrated, in particular in FIG. 1, means 14 are provided for advancing the respective container, or bottle, 13, in particular in the form of a corresponding rotating carousel, and on which the label is applied on the corresponding container, or bottle.

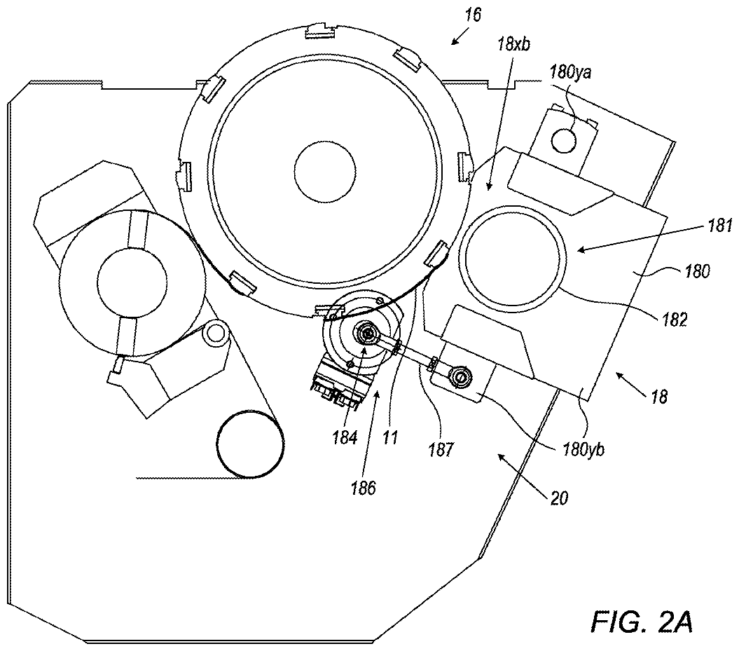

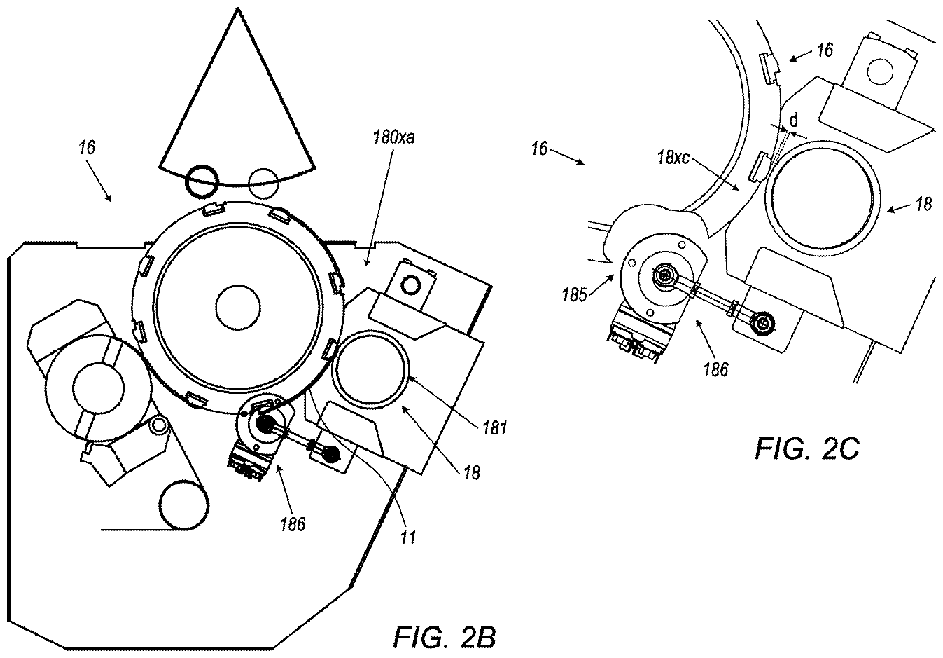

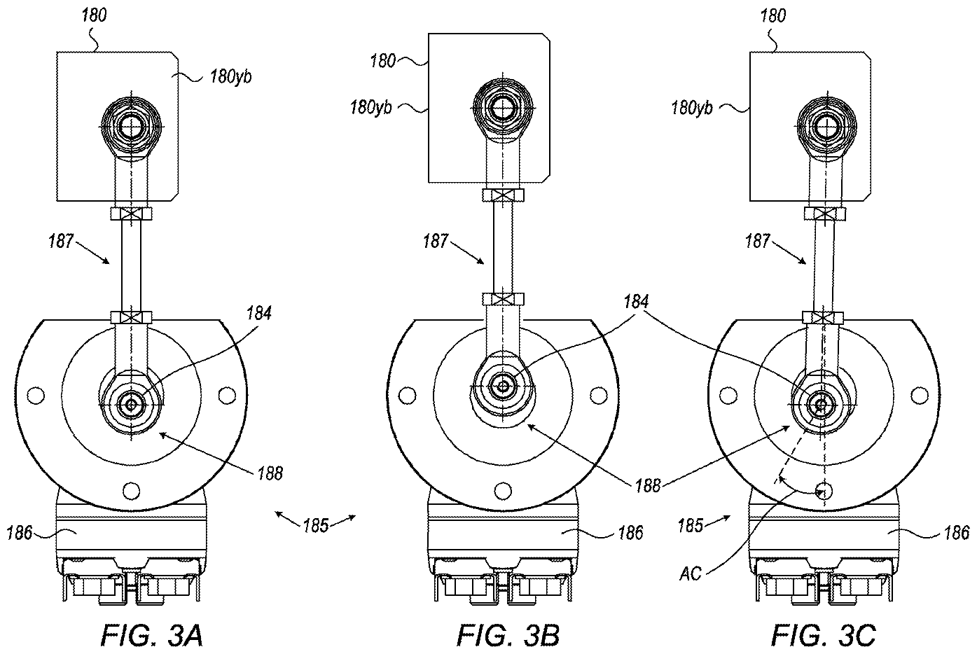

Said means 18 for applying a corresponding adhesive or glue are movable into a position 18xa for engaging said one or more corresponding parts of said label 11 and for applying thereon said adhesive or glue, in particular illustrated in FIG. 2B.

With advantage, as illustrated in FIG. 2C, said means 18 for applying a corresponding adhesive or glue are movable into a position 18xc, disengaged from said label 11 and in particular which lets the label freely pass without said adhesive or glue being applied, which position 18xc, disengaged from said label 11, and in particular which lets the label freely pass without said adhesive or glue being applied, is close to the label itself 11.

In this way, it is possible, when there is no container, or bottle, 13 in the position for receiving the respective label 11, to avoid applying glue to the corresponding label 11 and thus prevent this label, being lost, and wandering in the apparatus, from being able to get affixed in undesirable points thereof, forcing the need to carry out troublesome and time-consuming cleaning works, moreover with corresponding machine downtimes and related production losses.

In practice, advantageously, as can be seen from said figures, there are provided, as mentioned above, means 16 for transferring said label 11 onto said container, or bottle, 13, with said means 18 for applying a corresponding adhesive or glue which are movable into a position 18xa for engaging said label 11, and for pushing it against the same means 16 for transferring said label 11 onto said container, or bottle, 13, and for consequently applying said adhesive or glue on the label itself 11, as illustrated in said FIG. 2B.

In practice, as can be seen from said figures, advantageously, said means 18 for applying a corresponding adhesive or glue are movable into said position 18xc disengaged from, and close to, said label 11, and in particular which lets the label freely pass without said adhesive or glue being applied, which position 18xc disengaged from, and close to, said label 11, and in particular which lets the label freely pass without said adhesive or glue being applied, is close to said means 16 for transferring said label 11 onto said container, or bottle, 13, as illustrated in said FIG. 2C.

Advantageously, as can be seen from said figures and in particular from FIG. 2C, said position 18xc disengaged from, and close to, said label 11, and in particular which lets the label freely pass without said adhesive or glue being applied, is spaced apart from said label 11, or from said means 16 for transferring said label 11 onto said container, or bottle, 13, by a stretch “d” which is between 1 mm and 3 mm, and which is preferably in any case of about 1 mm.

In this way, it is possible to avoid applying said adhesive or glue to a respective label and at the same time quickly resume applying it to the next label.

Advantageously, as can be seen from said figures, said means 18 for applying a corresponding adhesive or glue, on said label 11, are movable into said position 18xc, disengaged from, and close to, said label 11, and in particular which lets the label freely pass without said adhesive or glue being applied, starting from said position 18xa for engaging said label 11 and for applying thereon said adhesive or glue.

As can be seen from said figures and in particular from FIG. 2A, in a particularly advantageous way, said means 18 for applying a corresponding adhesive or glue are movable into a rest position 18xb which is moved away from said label 11, or moved away from said means 16 for transferring said label 11 onto said container, or bottle, 13.

In particular, said rest position 18xb moved away from said label 11, or moved away from said means 16 for transferring said label 11 onto said container, or bottle, 13, is at a distance from said means 16 for transferring said label 11 onto said container, or bottle, 13, which is of about 10 mm.

Advantageously, as can be seen from said figures, said means 18 for applying a corresponding adhesive or glue, on said label 11, are also movable into said position 18xc, disengaged from, and close to, said label 11, starting from said rest position 18xb moved away from said label 11, or moved away from said means 16 for transferring said label 11 onto said container, or bottle, 13.

This movement of said means 18 for applying a corresponding adhesive or glue, on said label 11, is carried out in particular on the occasion of the application of the label, in particular of the first label, on the occasion of the start-up of the apparatus.

In this way, it is possible to be more timely in the application of the label, in particular of the first label, when starting the apparatus, thus avoiding delays in starting the activity of the labelling apparatus and consequent excessive accumulations of said containers, or bottles, 13 along the plant in which the present apparatus 10 is inserted.

As can be seen from the figures, with advantage, said position 18xc disengaged from, and close to, said label 11 is an intermediate position between said position 18xa for engaging said one or more corresponding parts of said label 11, and for applying thereon said adhesive or glue, and the rest position 18xb moved away from said label 11, or moved away from said means 16 for transferring said label 11, especially said position 18xc disengaged from, and close to, said label 11 being a position closer to said position 18xa for engaging said one or more corresponding parts of said label 11 and for applying thereon said adhesive or glue, than to said rest position 18xb moved away from said label 11.

Advantageously, as can be seen from said figures, said means 18 for applying a corresponding adhesive or glue, on said label 11, comprise a respective applicator member, in particular in the form of a rotatable applicator roller 181, which has a peripheral or circumferential surface 182 which is adapted to apply said adhesive or glue to said label 11, in particular said applicator roller 181 having a respective axis of rotation that is extended according to the vertical.

Advantageously, as can be seen from said figures, said means 18 for applying a corresponding adhesive or glue comprise corresponding means, or frame, 180, which support, or supports, said applicator member, or roller, 181, in particular freely rotatable.

As can be seen from said figures, advantageously, said means 18 for applying a corresponding adhesive or glue, on said label 11, comprise means 185 which are adapted to move said applicator member, or roller, 181, or said support means, or frame, 180, closer to, and away from, said means 16 for transferring said label 11 onto said container, or bottle, 13.

Advantageously, as can be seen from said figures, said means 185 which are adapted to move said applicator member, or roller, 181, or said support means, or frame, 180, closer to, and away from, said means 16 for transferring said label 11 onto said container, or bottle, 13, are adapted to move respectively forward and backward between said position 18xa for engaging said one or more corresponding parts of said label 11 and for applying thereon of said adhesive or glue, and said position 18xc disengaged from, and close to, said label 11 and in particular which lets the label freely pass without said adhesive or glue being applied.

Advantageously, as can be seen from said figures, said means 185 which are adapted to move said applicator member, or roller, 181, or said support means, or frame, 180, closer to, and away from, said means 16 for transferring said label 11 onto said container, or bottle, 13, are adapted to move respectively forward and backward between said rest position 18xb moved away from said label 11, or moved away from said means 16 for transferring said label 11 onto said container, or bottle, 13 and said position 18xc disengaged from, and close to, said label 11 and in particular which lets the label freely pass without said adhesive or glue being applied.

As can be seen from said figures, in a particularly advantageous way, said means 185 which are adapted to move said applicator member, or roller, 181, or said support means, or frame, 180, closer to, and away from, said means 16 for transferring said label 11 onto said container, or bottle, 13, are adapted to move respectively forward and backward between said position 18xa for engaging said one or more corresponding parts of said label 11 and for applying thereon said adhesive or glue, said rest position 18xb moved away from said label 11, or moved away from said means 16 for transferring said label 11 onto said container, or bottle, 13.

In this way, on corresponding operating occasions, said means 18 for applying a corresponding adhesive or glue, on said label 11, can be moved directly between said working positions.

Particularly advantageously, as can be seen from said figures, said means 185 which are adapted to move said applicator member, or roller, 181, or said support means, or frame, 180, closer to, and away from, said means 16 for transferring said label 11 onto said container, or bottle, 13, comprise corresponding actuating means 186. In particular, advantageously, as can be seen from said figures, said actuating means comprise a corresponding brushless motor 186.

As can be seen from said figures, with advantage, said support means, or frame, 180 are pivoted, in particular at one end 180ya of said support means, or framing, 12, and are rotatably moved closer to, and away from, said means 16 for transferring said label 11 onto said container, or bottle, 13, by said actuating means 186, in particular operating, or connected, at the opposite end 180yb of said support means, or frame, 180, for rotating, respectively forward and backward, the same support means, or frame, 180 with respect to said pivot 180ya.

With advantage, as can be seen from said figures, said actuating means 186 are connected to said applicator member, or roller, 181, or to said support means, or frame, 180, by means of a corresponding eccentric 184 adapted to move the same applicator member, or roller, 181, or the same support means, or frame, 180, forward and backward with respect to said means 16 for transferring said label 11, said eccentric 184 being in particular connected to said support means, or frame, 180, in particular at said end 180yb opposite to the pivot one 180ya, especially by means of a corresponding rod or connecting rod 187.

Advantageously, as can be seen from said figures, said eccentric 184 is connected to the rotatable shaft of said actuating means, or brushless motor, 186.

As can be seen from said figures, advantageously, said actuating means, or brushless motor, 186 have the respective output shaft, the axis of which is directed vertically, or, parallel to the axis of rotation of said applicator member, or roller 181, and/or to the axis of the pivot of rotation 180ya of said support means, or frame 180 carrying said applicator member, or roller, 181.

Advantageously, as can be seen from said figures, said eccentric 184 is movable into an angular position wherein said means 18 for applying a corresponding adhesive or glue are in said position 18xa for engaging said one or more corresponding parts of said label 11 and for applying thereon said adhesive or glue.

Advantageously, as can be seen from said figures, said eccentric 184 is movable into an angular position wherein said means 18 for applying a corresponding adhesive or glue are in said rest position 18xb moved away from said label 11, or from said means 16 for transferring said label 11 onto said container, or bottle, 13.

As can be seen from said figures, in a particularly advantageous way, said eccentric 184 is movable into an angular position wherein said means 18 for applying a corresponding adhesive or glue are in said position 18xc disengaged from, and close to, said label 11 and in particular which lets the label freely pass without said adhesive or glue being applied. Particularly advantageously, as can be seen from said figures, said actuating means 186, or brushless motor 186, are adapted, or is adapted, to rotate said eccentric 184 according to opposite angular directions.

Advantageously, as can be seen from said figures, said actuating means, or brushless motor 186, are adapted, or is adapted, to rotate said eccentric 184, respectively according to the opposite angular directions, between said position 18xa for engaging said label 11, and for applying thereon said adhesive or glue, and said position 18xc disengaged from, and close to, said label 11, and in particular which lets the label freely pass without said adhesive or glue being applied, according to an angular width AC which is less than 90°, and preferably which is of about 30°.

As can be seen from said figures, with advantage, said actuating means, or brushless motor 186, are adapted, or is adapted, to rotate said eccentric 184, respectively according to the opposite angular directions, between said rest position 18xb moved away from said label 11, or moved away from said means 16 for transferring said label 11 onto said container, or bottle, 13, and said position 18xc disengaged from, and close to, said label 11, and in particular which lets the label freely pass without said adhesive or glue being applied, according to an angular width which is greater than 90°, and preferably which is of about 150°.

With advantage, as can be seen from said figures, said actuating means, or brushless motor 186, are adapted, or is adapted, to rotate said eccentric 184, respectively according to the opposite angular directions, between said position 18xa for engaging said label 11, and for applying thereon said adhesive or glue, and said rest position 18xb moved away from said label 11, or moved away from said means 16 for transferring said label 11 onto said container, or bottle, 13, according to an angular width which is equal, or substantially equal, to 180°.

Advantageously, as can be seen from said figures, said means 185 which are adapted to move said applicator member, or roller 181, or said support means, or frame, 180, closer to, and away from, said means 16 for transferring said label 11 onto said container, or bottle, 13 are arranged below a corresponding plane, in particular horizontal, 120 supporting said support means, or framing, 12, above which said label 11 is provided and/or said adhesive or glue is provided on the label itself 11 and/or said label 11 is applied on the respective container, or bottle, 13.

As can be seen from said figures, advantageously, said eccentric 184 is carried by a block 188 integral with said actuating means, or brushless motor, 186, which said block 188 being supported to be freely rotatable, in particular through a respective bearing 189, by said support means, or framing, 12, in particular by a corresponding bracket 123, which is fixed to said support plane 120 of said support means, or framing, 12 and on which said actuating means, or said brushless motor, 186 are hung, or is hung.

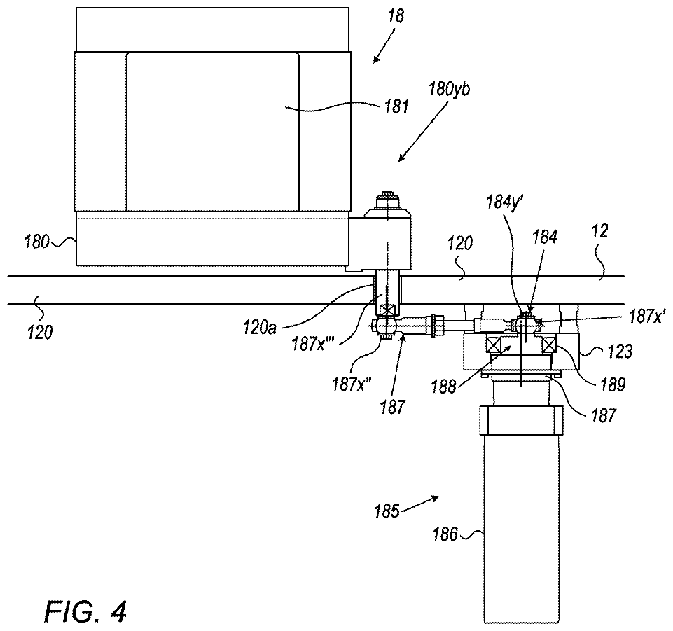

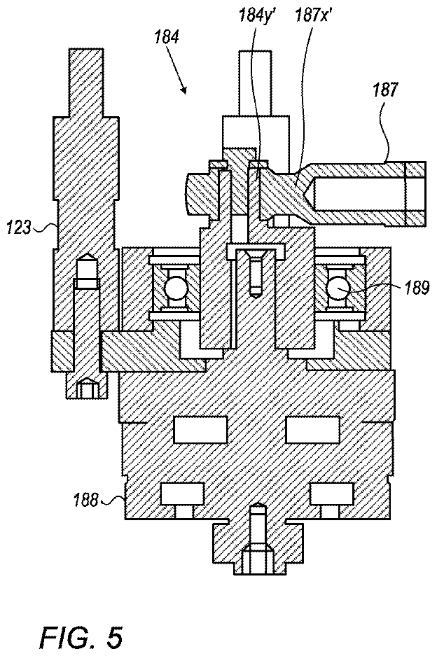

Advantageously, as can be seen from said figures and in particular from said FIG. 4, said rod or connecting rod 187 has a respective end 187x′ rotatably connected to the pin 184y′ of said eccentric 184 and the other end 187x″, being integral with a respective rod 187x in particular vertical and/or passing through a corresponding opening 120a obtained in said plane, in particular horizontal, 120 supporting said support means, or framing, 12 and connected to the corresponding end 180yb of said support means, or frame, 180.

Advantageously, as can be seen from said figures and in particular from FIG. 1, said means for transferring said label 11 onto said container, or bottle, 13 are in the form of a rotatable member, or drum, 161 having a respective axis of rotation directed vertically, or parallel to the axis of rotation of said applicator member, or roller 181, and/or to the axis of the pivot of rotation 180ya of said support means, or frame, 180 carrying said applicator member, or roller 181.

As can be seen from said figures and in particular from FIG. 1, in a particularly advantageous way, said means for transferring said label 11 onto said container, or bottle, 13, or said rotatable member, or drum 161, comprises a plurality of, in particular in a number equal to four, circumferential zones 162 for engaging and retaining a corresponding label 11, which label is retained on the respective area through the corresponding suction means 163. In particular, the respective engagement zone 162 has respective outermost areas 164, 165, circumferentially spaced apart and radially protruding, for retaining opposite ends of said label 11 and for pushing in engagement said label 11 against said rotatable member, or drum 181 to have a corresponding adhesive or glue applied, on the corresponding outermost part of said label 11. In particular, said outermost areas 164, 165 being defined by corresponding radially yielding slide portions.

Particularly advantageously, as can be seen from said figures and in particular from FIG. 1, means 20 for cutting a respective label 11 from a corresponding label strip 11′ are provided, which are in particular adapted to transfer the respective label 11 onto said circumferential zone 162 for engaging and retaining a corresponding label 11 of said means 16 for transferring said label 11, to, or onto, said container, or bottle, 13. As illustrated, said cutting means 20 are in particular supported by said support means, or framing, 12 of the same apparatus 10.

Advantageously, as can be seen from said figures and in particular from FIG. 1, said means 16 for transferring said label 11 onto said container, or bottle, 13 move forward, in particular rotating, preferably continuously, between respective stations, which are especially circumferentially spaced apart, respectively and/or sequentially provided for said means 20 for cutting a respective label 11 from a label strip 11′, for said means 18 for applying a corresponding adhesive or glue, on said label 11, and for said means 14 for advancing said container, or bottle, 13 at the zone of application of the respective label 11 on the same container, or bottle, 13.

In practice, as is evident, the technical characteristics illustrated above allow, individually or in a respective combination, achieving one or more of the following advantageous results:
it is possible, when there is no container, or bottle, in the position for receiving the respective label, to avoid applying glue to the corresponding label and thus prevent this label, being lost, and wandering in the apparatus, from being able to get affixed in undesirable points thereof, forcing the need to carry out troublesome and time-consuming cleaning works, moreover with corresponding machine downtimes and related production losses;
it is possible to avoid applying said adhesive or glue to a respective label and at the same time quickly resume applying it to the next label;
it is possible to be more timely in the application of the label, in particular of the first label, when starting the apparatus, in this way avoiding delays and excessive accumulations of said container, or bottle, along the plant in which this apparatus is inserted.

The present invention is susceptible to evident industrial application. The person skilled in the art will also be able to imagine numerous modifications and/or variations to be made to the same invention, while remaining within the scope of the inventive concept, as extensively explained. Furthermore, the person skilled in the art will be able to imagine further preferred embodiments of the invention comprising one or more of the above illustrated features of the above-referenced preferred embodiment, in particular as set forth in the appended claims. Moreover, it must also be understood that all the details of the invention can be replaced by technically equivalent elements.

1-36. (canceled)

37. Apparatus for applying a respective label, on a corresponding container, in particular in the form of a bottle, especially in the form of a container, or bottle, in plastic material; in particular said label being adapted to circumferentially wrap the body of said container, or bottle; the apparatus comprising means for applying a corresponding adhesive or glue on one or more corresponding parts, in particular on the outermost parts, of the respective label; said means for applying a corresponding adhesive or glue being movable into a close position for engaging said one or more corresponding parts of said label and for applying thereon said adhesive or glue; wherein said means for applying a corresponding adhesive or glue are movable into a position disengaged from said label, and in particular which lets the label freely pass without said adhesive or glue being applied, which position disengaged from said label, and in particular which lets the label freely pass without said adhesive or glue being applied, is close to the label itself.

38. Apparatus according to claim 37, wherein means for transferring said label onto said container or bottle are provided, with said means for applying a corresponding adhesive or glue which are movable into a position for engaging said label, and for pushing said label against the same means for transferring said label onto said container, or bottle, and consequently applying said adhesive or glue on the label itself.

39. Apparatus according to claim 38, wherein said means for applying a corresponding adhesive or glue are movable into said position disengaged from, and close to, said label, and in particular which lets the label freely pass without said adhesive or glue being applied, which position disengaged from, and close to, said label, and in particular which lets the label freely pass without said adhesive or glue being applied, is close to said means for transferring said label onto said container, or bottle.

40. Apparatus according to claim 37, wherein said position disengaged from, and close to, said label, and in particular which lets the label freely pass without said adhesive or glue being applied, is spaced apart from said label, or from said means for transferring said label, onto said container, or bottle, by a stretch which is between 1 mm and 3 mm, and which is preferably of about 1 mm.

41. Apparatus according to claim 37, wherein said means for applying a corresponding adhesive or glue, onto said label, are movable into said position, disengaged from, and close to, said label, and in particular which lets the label freely pass without said adhesive or glue being applied, starting from said position for engaging said label and for applying thereon said adhesive or glue.

42. Apparatus according to claim 37, wherein said means for applying a corresponding adhesive or glue are movable into a rest position moved away from said label, or moved away from said means for transferring said label onto said container, or bottle.

43. Apparatus according to claim 42, wherein said rest position moved away from said label, or moved away from said means for transferring said label, onto said container, or bottle, is at a distance from said means for transferring said label onto said container, or bottle, which is of about 10 mm.

44. Apparatus according to claim 42, wherein said means for applying a corresponding adhesive or glue, onto said label, are movable into said position, disengaged from, and close to, said label, starting from said rest position moved away from said label, or moved away from said means for transferring said label onto said container, or bottle.

45. Apparatus according to claim 42, wherein said position disengaged from, and close to, said label is an intermediate position between said position for engaging said one or more corresponding parts of said label, and for applying thereon said adhesive or glue, and the rest position moved away from said label, or moved away from said means for transferring said label, especially said position disengaged from, and close to, said label being a position closer to said position for engaging said one or more corresponding parts of said label and for applying thereon said adhesive or glue.

46. Apparatus according to claim 37, wherein said means for applying a corresponding adhesive or glue, on said label, comprise a respective applicator member, in particular in the form of a rotatable applicator roller, which has a peripheral or circumferential surface which is adapted to apply said adhesive or glue to said label.

47. Apparatus according to claim 37, wherein said means for applying a corresponding adhesive or glue comprise corresponding means, or a frame, which support, or supports, said applicator member, or roller, in particular freely rotatable.

48. Apparatus according to claim 37, wherein said means for applying a corresponding adhesive or glue, onto said label, comprise means which are adapted to move said applicator member, or roller, or said support means, or frame, closer to, and away from, said means for transferring said label, onto said container, or bottle.

49. Apparatus according to claim 48, wherein said means which are adapted to move said applicator member, or roller, or said support means, or frame, closer to, and away from, said means for transferring said label onto said container, or bottle, are adapted to move respectively forward and backward between said position for engaging said one or more corresponding parts of said label and for applying thereon said adhesive or glue, and said position disengaged from, and close to, said label, and in particular which lets the label freely pass without said adhesive or glue being applied.

50. Apparatus according to claim 48, wherein said means which are adapted to move said applicator member, or roller, or said support means, or frame, closer to, and away from, said means for transferring said label onto said container, or bottle, are adapted to move respectively forward and backward between said rest position moved away from said label, or moved away from said means for transferring said label on said container, or bottle, and said position disengaged from, and close to, said label, and in particular which lets the label freely pass without said adhesive or glue being applied.

51. Apparatus according to claim 48, wherein said means which are adapted to move said applicator member, or roller, or said support means, or frame, closer to, and away from, said means for transferring said label onto said container, or bottle, are adapted to move respectively forward and backward between said position for engaging said one or more corresponding parts of said label and for applying thereon said adhesive or glue, said rest position moved away from said label, or moved away from said means for transferring said label onto said container, or bottle.

52. Apparatus according to claim 48, wherein said means which are adapted to move said applicator member, or roller, or said support means, or frame, closer to, and away from, said means for transferring said label onto said container, or bottle, comprise corresponding actuating means.

53. Apparatus according to claim 52, wherein said support means, or frame, are pivoted, in particular at one end of said support means, or framing, and are rotatably moved closer to, and away from said means for transferring said label onto said container, or bottle, by said actuating means, in particular operating, or connected, at the opposite end of said support means, or frame, for rotating, respectively forward and backward, the same support means, or frame, with respect to said pivot.

54. Apparatus according to claim 52, wherein said actuating means are connected to said applicator member, or roller, or to said support means, or frame, by means of a corresponding eccentric adapted to move said applicator member, or roller, or said support means, or frame, forward and backward with respect to said means for transferring said label, said eccentric being in particular connected to said support means, or frame, in particular at said end opposite to the pivot one, especially by means of a corresponding rod or connecting rod.

55. Apparatus according to claim 54, wherein said eccentric is connected to the end of the rotatable shaft of said actuating means, or brushless motor.

56. Apparatus according to claim 52, wherein said actuating means, or brushless motor, have a respective output shaft, the axis of which is directed vertically, or, parallel to the axis of rotation of said applicator member, or roller, and/or to the axis of the pivot of rotation of said support means, or frame carrying said applicator member, or roller.
